(19) United States
(12) Patent Application Publication
(10) Pub. No.: US 2021/0243994 A1
(43) Pub. Date: Aug. 12, 2021

(54) AMMONIA ABATEMENT FOR ANIMAL LITTER

(71) Applicant: CHEMTRADE CHEMICALS US LLC, PARSIPPANY, NJ (US)

(72) Inventor: Rex A. JOHNS, Jonesboro, AR (US)

(73) Assignee: CHEMTRADE CHEMICALS US LLC, PARAIPPANY, NJ (US)

(21) Appl. No.: 15/931,376

(22) Filed: May 13, 2020

Related U.S. Application Data
(60) Provisional application No. 62/972,559, filed on Feb. 10, 2020.

(51) Int. Cl. A01K 1/015

(52) U.S. Cl. CPC A01K 1/0154; A01K 1/0155; A01K 2227/30

(57) ABSTRACT

A method for preparing an ammonia abatement additive for poultry litter that is formulated to assure activation in an interior environment having various relative humidity conditions. The method includes obtaining a blended litter amendment composition that, based on weight, is about 40% deliquescent salt and about 60% aluminum sulfate, relative to a total weight of the two components. The composition can be made by the user or received, already blended, from a third party. To this blended composition that has been obtained, additional deliquescent salt is added in an amount such that the total amount of deliquescent salt is effective to activate the alum-containing ammonia abatement additive at the targeted low relative humidity condition in the interior of a poultry house. The composition is a sub-component of the ammonia abatement additive which may or may not contain additional compounds. The specified relative proportions (i.e., 40% deliquescent salt and 60% alum) only consider the proportion of deliquescent salt and the proportion of alum relative to the sum of the two components, based on weight. If there are other, extraneous compounds included in the ammonia abatement additive, those extraneous compounds are not counted in the defined and claimed proportions.

### CROSS-REFERENCE TO RELATED APPLICATIONS

This application claims the benefit of U.S. Provisional Application No. 62/972,559 filed Feb. 10, 2020, said application is expressly incorporated by reference herein in its entirety.

### FIELD

The presently disclosed technology relates to improvements in the treatment of animal litter using aluminum sulfate (“alum”) to reduce the generation of ammonia from animal waste in the litter. More particularly, the technology relates to the combination of a deliquescent salt with the alum to increase the presence of water in the alum and activate its ammonia abatement capabilities. In a more specific example, the technology relates to compositions and methods for adapting poultry litter located in a poultry house.

### DETAILED DESCRIPTION

Within certain animal enclosures, and especially within poultry houses, high amounts of ammonia are generated that negatively affect the resident animals. The adverse effects can include such things as diminished weight gain and increased mortality among the housed animals, and especially in young chicks. To improve animal comfort and wellbeing, litter having various components is put down ahead of the animals' introduction to the space, and that initial installation of litter is typically maintained throughout their stay. To treat the litter and better alleviate the negative effects of waste-generated ammonia in the enclosure, an ammonia abatement additive is applied to the litter. According to the teachings of the presently disclosed technology, the additive includes a deliquescent salt, such as calcium chloride, blended with the alum in particular discovered and advantageous proportions, in dependence upon the expected relative humidity of the intended eventual use-environment.

The alum is the compound that, when activated, neutralizes ammonia. Proper activation of the alum, however, is dependent upon sufficient moisture being present in the alum to induce its pH reducing functionality that neutralizes the offending ammonia. To gain the necessary moisture content in the alum, deliquescent salt is incorporated. Deliquescent salts, by definition, are sufficiently hydrophilic that they have a capacity to absorb enough moisture out of atmospheric air to liquefy themselves. The presence of the deliquescent salt initiates hydrolysis and increases the moisture level in the alum. A surprising discovery of the present technology is that the proportional amounts of deliquescent salt to alum correlate to expected relative humidities within an animal enclosure.

In the case of poultry houses, recent design features intended to increase the comfort and wellbeing of the birds have actually compromised the activation capabilities of the alum, in poultry litter, to abate ammonia produced by the birds' waste. A specific example is the use of “tunnel ventilation” and other enhanced air circulation methods in poultry houses to cool the birds and better draw in fresh air. An unintended, but discovered consequence of this increased air circulation is an over-drying of the litter. By this applicant's research, this effect has been discovered to uniquely track the relative humidity outside the poultry house, which in turn effects the relative humidity inside the poultry house. As a result, customized blending of deliquescent salt and alum has been invented and is described and claimed herein.

Another situation that has been detected in modern poultry house constructions is over-wetting of freshly applied poultry litter under certain conditions and/or circumstances. The absorption of too much water by animal litter can have a detrimental effect because wet litter tends to reduce animal weight gain performance and provides a hospitable environment for pathogens. Wet litter also enhances the presence of pathogen vectors and attracts destructive insects such as flies and beetles that disturb the animals and reduce feed conversion to weight gain.

One such overly damp situation occurs when the slab of the poultry house is cold enough to condense moisture out of the air, wetting the surface of the concrete, and in turn, litter deposited thereupon. In this regard, the amount of surface wetness correlates to the degree of relative humidity inside the poultry house. The same effect, but occurring by a different modality, is slab “weeping” of water up through the concrete from the ground below. Both situations (condensate and weeping) result in overly moist or wet litter that hampers the ability of applied alum to neutralize ammonia. To combat these effects on the alum, based on this applicant's research, unique blends of deliquescent salt in proportion to alum have been discovered and are described and claimed herein. Among other aspects, the alum content of the litter additive is increased, in correlation with the expected amount of excess moisture, thereby potentiating the alum's ammonia neutralizing capabilities.

Regarding the compositional blends and blending of the deliquescent salt and alum, it is contemplated that the specially designed mixtures of the two components can be pre-mixed, or sequentially added to the litter, bedding or animal waste to be treated. Regardless, the components are ultimately blended together with the target media, such as animal litter.

Suitable litter compositions or media can include a mixture of one or more of wood shavings, secondary paper, nut hulls, bran hulls, rice hulls, wood chips, sand and sawdust as examples. Other materials are known to those skilled in the art.

Suitable deliquescent materials include chlorides such as magnesium chloride, calcium chloride, manganese chloride, ferric chloride and zinc chloride; and other metal salts including ammonium citrate, calcium chlorate, calcium iodide, calcium nitrite, calcium nitrate, cobaltous ammonium chloride, cobaltous iodide, cupric chlorate, cupric nitrate, ferric chloride, ferric lactate, ferric nitrate, ferrous iodide, magnesium ammonium chloride, magnesium nitrate, magnesium nitrite, manganese oxide, manganese sulfate, phosphoric acid, phosphorus oxide, potassium acetate, potassium carbonate, potassium iodide, potassium phosphate, sodium bisulfate, sodium acetate, stannic sulfate and zinc chloride.

Deliquescent salts including calcium chloride, magnesium chloride, sodium bisulfate, manganese chloride, zinc chloride, anhydrous ferric chloride, magnesium nitrate, calcium nitrate, potassium acetate and sodium acetate, are preferred. Since some of these deliquescent salts may have adverse effects on some animals, such as poultry chicks, the types of the salts must be carefully selected. The addition of the deliquescent material is also regarded as aiding control of nuisance dust in the animal housing. Calcium chloride, being a very effective deliquescent material, absorbs moisture from the atmosphere, even very dry atmospheres, until a solution is formed; this absorbed water becomes the activator for alum.

The following are example embodiments that are within the scope of this disclosure. Other, different and/or broader embodiments are also within the scope of this disclosure, some of which can include elements of one example embodiment combined with elements of another example embodiment (to the extent combinable), or subsets of elements of one or another specific example embodiment.

In a first characterization, the presently disclosed technology takes the form of a method for preparing an ammonia abatement additive for poultry litter that is formulated to assure activation in an interior environment having a low relative humidity which is being targeted for ammonia abatement activation. That is to say, a poultry house will be located in a climate and location having ambient (outdoor) characteristics that influence the conditions of the house's interior environment, but they will not necessarily be identical. Because it is within the interior environment that the animals are actually raised, the present technology is concerned with the relative humidity of that interior space, and in particular, the interior space of a poultry house in which the relative humidity prior to the birds' occupation is low, and that degree of relative humidity is considered “targeted” because it is the relative humidity under which the ammonia abatement additive will desirably perform.

The method comprises (meaning includes, but is not limited to) obtaining a blended litter amendment composition that, based on weight, is about 40% deliquescent salt and about 60% aluminum sulfate, relative to a total weight of the two components. The composition is characterized as being “obtained” because it is contemplated that the blended composition may be made by the user or received, already blended, from a third party. To this blended composition that has been obtained, additional deliquescent salt is added in an amount such that the total amount of deliquescent salt is effective to activate the alum-containing ammonia abatement additive at the targeted low relative humidity condition in the interior of a poultry house. The “composition” is a sub-component of the “ammonia abatement additive” which may or may not contain additional compounds. The specified relative proportions (i.e., 40% deliquescent salt and 60% alum) only consider the proportion of deliquescent salt and the proportion of alum relative to the sum of the two components, based on weight. If there are other, extraneous compounds included in the ammonia abatement additive, those extraneous compounds are not counted in the defined and claimed proportions.

In one example, the amount of additional deliquescent salt is sufficient to bring a resulting adjusted litter amendment composition to about 60% deliquescent salt compared to about 40% aluminum sulfate. In this instance, the resulting adjusted litter amendment composition corresponds to a targeted low relative humidity interior environment having about 45% or less relative humidity.

In another example, the amount of additional deliquescent salt is sufficient to bring a resulting adjusted litter amendment composition to about 70% deliquescent salt compared to about 30% aluminum sulfate. In this instance, the resulting adjusted litter amendment composition corresponds to a targeted low relative humidity interior environment having about 40% or less relative humidity.

In yet another example, the amount of additional deliquescent salt is sufficient to bring a resulting adjusted litter amendment composition to about 80% deliquescent salt compared to about 20% aluminum sulfate. In this instance, the resulting adjusted litter amendment composition corresponds to a targeted low relative humidity interior environment having about 35% or less relative humidity.

In still another example, the amount of additional deliquescent salt is sufficient to bring a resulting adjusted litter amendment composition to about 90% deliquescent salt compared to about 10% aluminum sulfate. In this instance, the resulting adjusted litter amendment composition corresponds to a targeted low relative humidity interior environment having about 30% or less relative humidity.

In yet, still another example, the amount of additional deliquescent salt is sufficient to bring a resulting adjusted litter amendment composition to about 50% deliquescent salt compared to about 50% aluminum sulfate. In this instance, the resulting adjusted litter amendment composition corresponds to a targeted low relative humidity interior environment having about 50% or less relative humidity.

In a second characterization, the presently disclosed technology takes the form of a method for providing an ammonia abatement additive for poultry litter that is formulated to activate prior to the introduction of poultry onto the litter. The method comprises providing an amount of deliquescent salt having a first weight and providing an amount of aluminum sulfate having a second weight, and wherein the amount of aluminum sulfate is about one and one-half times the amount of deliquescent salt, based on weight.

In one example, the ammonia abatement additive for poultry litter is formulated to activate in average US relative humidity. For present purposes, average US relative humidity is considered to be about 60% relative humidity.

In another example, the additional amount of provided aluminum sulfate is approximately equal to twice the amount of already-provided deliquescent salt, based on weight. In this case, the additional amount of aluminum sulfate is provided in correspondence with a use-environment of greater than 70% relative humidity.

In yet another example, the additional amount of provided aluminum sulfate is approximately equal to three times the amount of already-provided deliquescent salt, based on weight. In this case, the additional amount of aluminum sulfate is provided in correspondence with a use-environment of greater than 80% relative humidity.

In still another example, the additional amount of provided aluminum sulfate is approximately equal to four times the amount of already-provided deliquescent salt, based on weight. In this case, the additional amount of aluminum sulfate is provided in correspondence with a use-environment of greater than 90% relative humidity.

In the second characterization disclosed above, the deliquescent salt constitutes about 40% and the aluminum sulfate constitutes about 60% of the combination of the two components.

In an additional characterization, the presently disclosed technology takes the form of a method for providing an ammonia abatement additive for poultry litter that is formulated to activate prior to the introduction of poultry onto the litter. The method comprises providing an amount of aluminum sulfate having a first weight and providing an amount of deliquescent salt having a second weight, and wherein the amount of aluminum sulfate is about nine times the amount of deliquescent salt, based on weight. This combination has been found to be particularly useful when the alum has not been activated until shortly before chick introduction.

Although the present technology has been described in terms of specific components and relative amounts thereof, other additives can be included as will be known to one skilled in the art. Thus the disclosed technology is only meant to be limited by the scope of the appended claims.

What is claimed is:

1. A method for preparing an ammonia abatement additive for poultry litter that is formulated to activate in a targeted low relative humidity interior environment, the method comprising:
obtaining a blended litter amendment composition, said composition comprising, based on weight, about 40% deliquescent salt and about 60% aluminum sulfate; and
adding an amount of additional deliquescent salt, wherein the total amount of deliquescent salt is effective to activate the ammonia abatement additive at a targeted low relative humidity condition in an interior environment.

2. The method as recited in claim 1 wherein the amount of additional deliquescent salt is sufficient to bring a resulting adjusted litter amendment composition to about 60% deliquescent salt compared to about 40% aluminum sulfate.

3. The method as recited in claim 2 wherein the resulting adjusted litter amendment composition of about 60% deliquescent salt compared to about 40% aluminum sulfate constitutes an ammonia abatement additive for poultry litter corresponding to a targeted low relative humidity interior environment having about 45% or less relative humidity.

4. The method as recited in claim 1 wherein the amount of additional deliquescent salt is sufficient to bring a resulting adjusted litter amendment composition to about 70% deliquescent salt compared to about 30% aluminum sulfate.

5. The method as recited in claim 4 wherein the resulting adjusted litter amendment composition of about 70% deliquescent salt compared to about 30% aluminum sulfate constitutes an ammonia abatement additive for poultry litter corresponding to a targeted low relative humidity interior environment having about 40% or less relative humidity.

6. The method as recited in claim 1 wherein the amount of additional deliquescent salt is sufficient to bring a resulting adjusted litter amendment composition to about 80% deliquescent salt compared to about 20% aluminum sulfate.

7. The method as recited in claim 6 wherein the resulting adjusted litter amendment composition of about 80% deliquescent salt compared to about 20% aluminum sulfate constitutes an ammonia abatement additive for poultry litter corresponding to a targeted low relative humidity interior environment having about 35% or less relative humidity.

8. The method as recited in claim 1 wherein the amount of added deliquescent salt is sufficient to bring a resulting adjusted litter amendment composition to about 90% deliquescent salt compared to about 10% aluminum sulfate.

9. The method as recited in claim 8 wherein the resulting adjusted litter amendment composition of about 90% deliquescent salt compared to about 10% aluminum sulfate constitutes an ammonia abatement additive for poultry litter corresponding to a targeted low relative humidity interior environment having about 30% or less relative humidity.

10. The method as recited in claim 1 wherein the amount of added deliquescent salt is sufficient to bring a resulting adjusted litter amendment composition to about 50% deliquescent salt compared to about 50% aluminum sulfate.

11. The method as recited in claim 10 wherein the resulting adjusted litter amendment composition of about 50% deliquescent salt compared to about 50% aluminum sulfate constitutes an ammonia abatement additive for poultry litter corresponding to a targeted low relative humidity interior environment having about 50% or less relative humidity.

12. A method for providing an ammonia abatement additive for poultry litter that is formulated to activate prior to the introduction of poultry onto the litter, the method comprising:
providing an amount of deliquescent salt having a first weight; and
providing an amount of aluminum sulfate having a second weight, wherein the amount of aluminum sulfate is about one and one-half times the amount of deliquescent salt, based on weight.

13. The method as recited in claim 12 wherein the ammonia abatement additive for poultry litter is formulated to activate in average US relative humidity.

14. The method as recited in claim 13 wherein average US relative humidity is about 60% relative humidity.

15. The method as recited in claim 12 further comprising:
providing additional aluminum sulfate in an amount approximately equal to twice the amount of already-provided deliquescent salt, based on weight.

16. The method as recited in claim 15 wherein the additional amount of aluminum sulfate is provided in correspondence with a use-environment of greater than 70% relative humidity.

17. The method as recited in claim 12 further comprising:
providing additional aluminum sulfate in an amount approximately equal to three times the amount of already-provided deliquescent salt, based on weight.

18. The method as recited in claim 17 wherein the additional amount of aluminum sulfate is provided in correspondence with a use-environment of greater than 80% relative humidity.

19. The method as recited in claim 12 further comprising:
providing additional aluminum sulfate in an amount approximately equal to four times the amount of already-provided deliquescent salt, based on weight.

20. The method as recited in claim 19 wherein the additional amount of aluminum sulfate is provided in correspondence with a use-environment of greater than 90% relative humidity.

21. The method as recited in claim 12 wherein the deliquescent salt constitutes about 40% and the aluminum sulfate constitutes about 60% of the combination of those two components.

22. A method for providing an ammonia abatement additive for poultry litter that is formulated to activate prior to the introduction of poultry onto the litter, the method comprising:
providing an amount of aluminum sulfate having a first weight; and
providing an amount of deliquescent salt having a second weight, wherein the amount of aluminum sulfate is about nine times the amount of deliquescent salt, based on weight.
